(19) United States
(12) Patent Application Publication
(10) Pub. No.: US 2008/0006304 A1
(43) Pub. Date: Jan. 10, 2008

(54) FLOCK TANK

(75) Inventors: Michael Treherne, Blackfalds (CA); Donald George Hollman, Red Deer (CA)

Correspondence Address: SANDER R. GEISING, 600, 4911-51 STREET, RED DEER, AB, T4N-6V4, CA

(73) Assignee: MDK INNOVATIONS INC., Red Deer (CA)

(21) Appl. No.: 11/775,812

(22) Filed: Jul. 10, 2007

(30) Foreign Application Priority Data
Jul. 10, 2006 (CA) 2551684

(51) Int. Cl. B01D 24/24; B01D 21/02; B08B 3/04

(52) U.S. Cl. 134/34; 210/178; 210/194; 210/209; 210/220; 210/513

(57) ABSTRACT

In one aspect the invention provides a floc tank, for separate drilling fluid into an upper fluid fraction having a reduced concentration of solids and a lower solids fraction having a higher concentration of solids, and having at least one compartment, said floc tank comprising at least one jet manifold member mounted inside the periphery of at least one compartment, a plurality of jet nozzles mount on, and in communication with, the at least one jet manifold member, a fluid supply manifold in communication with the at least one jet manifold member; and a source of fluid for said fluid supply manifold. Additional aspects are also provided.

### FIELD OF THE INVENTION

The present invention relates to a flock, floc or flocculation tank for use in oilfield drilling operations and, more particularly, to a flock, floc or flocculation tank having a solids removal system comprising a unique arrangement of fluid jet nozzles mounted on peripheral manifolds in, or under, one or more of the tank's compartments for urging accumulating and settled solids toward drain openings in the floc tank. The term floc tank is used herein to encompass the various spelling variations, i.e. meaning flock tank, floc tank and/or flocculation tank.

### BACKGROUND OF THE INVENTION

Wells for recovering oil, gas and the like are typically created by drilling into an underground source using a hollow drill string supported in a drilling rig. The drill string includes a drill bit at the lower end that is rotated into the ground to create a wellbore. As the drill bit is rotated, drilling fluid (often called drilling mud) is pumped down through the interior of the drill string to pass through the bit and return to the surface in the wellbore external to the drill string. The drilling fluid acts to lubricate the drill bit and carries the loose solids created by the drill bit to the surface. At the surface, the used drilling fluid is collected and recycled by removing some or all of the solids.

Equipment and methods for handling the drilling fluid to remove solids in order to recycle the drilling fluid are well known. Floc tanks are designed to allow the suspended solids to precipitate or settle on the tank bottom. The treated drilling fluid can then be reused for further drilling operations. Often a flocculating agent or chemical is added to the floc tank to promote removal of solids from the drilling fluid. Other equipment such as shale shakers, settling tanks and centrifuge or cyclone separators may also be used.

One common problem with floc tanks is that oilfield personnel and/or vacuum (HVAC) truck drivers must periodically climb into the floc tank to wash and shovel out this muddy sludge of precipitated and settled solids; usually into a vacuum line from the vacuum truck that has been inserted into the relevant floc tank's compartment. The flocculating and drilling operations are usually halted for this to occur. Sometimes connection lines or elbows are provided or permanently mounted into each compartment of the floc tank, so as to facilitate a quick connection directly to vacuum truck's vacuum line. But even with such elbows, flocculating and drilling operations are still halted to allow for cleanout operations to finish.

Removal of this muddy sludge and/or shale into the vacuum line is very time consuming and is done on a compartment-by-compartment basis. It is also heavy, dirty and dangerous work. Often a second worker is required to stand outside/above the worker inside a floc tank's compartment, to watch or spot the worker inside in case the worker in the bottom of a floc tank's compartment gets accidentally sucked against or partially into the vacuum line's inlet.

Because of the necessity of periodic clean-outs by a worker having to climb inside the floc tank's compartments, floc tanks are traditionally open at their top, to allow entry of the workers. Oilfield workers, however, will sometimes move from a mud tank (usually placed adjacent a floc tank) to another location on the drilling site by walking along the side edge of the floc tank. As can be imagined, this practice is somewhat dangerous and it is not uncommon for such a worker to become unbalanced and fall either into, or along side of, the floc tank.

Furthermore, a significant amount of additional water is usually required to wash the muddy/shale sludge into the vacuum, or connection, line's inlet; after a vacuum truck has drained the majority of the fluid volume from the floc tank's compartments. Water conservation, during drilling operations, is desirable for both economic and environmental concerns As mentioned above, another concern with the necessity of periodic clean-outs of floc tanks is that the whole drilling operation will generally have to be shut-down, stopped or halted while the clean-out is being done. This can be a costly operation in itself. Canadian patent application no. 2,485,875 by Smith, the entirety of which is incorporated herein by reference, discloses a settling tank and a method for separating a solids containing fluid which does away with the need for a separate vacuum truck to remove the settled solids and allows for drilling operations to continue. However, the apparatus and method taught by Smith involve very large, expensive components and equipment and utilizes at least one sizeable and expensive centrifuge. The Smith application also relies on the traditional method of removing the solids from the bottom of the tank's compartments, i.e. by means of a vacuum line or pipe to suck up the solids from the bottom and direct them out of the tank's compartments, in this case into the centrifuge (as opposed to directing them into a vacuum truck).

Finally, when using traditional floc tanks during winter operation, there is a significant risk of the fluid in the tank freezing solid. The current method to prevent such freezing is to immerse a steam line or steam wand into one or more of the floc tank's compartments. Like the situation of inserting a vacuum line into the floc tank's compartment, this scenario has safety concerns, including concerns about workers or personnel having to lean over the compartment while holding a hot steam line or wand.

Thus, there is a need in the industry for a floc tank that avoids the disadvantages of the prior art.

### SUMMARY OF THE INVENTION

The present invention is directed to overcoming the prior art deficiencies of floc tanks, including disadvantage in relation to cleaning out the floc tank, in relation to winter operations of the floc tank and in relation to flocculating efficiency.

In one aspect the invention provides a floc tank, for separate drilling fluid into an upper fluid fraction having a reduced concentration of solids and a lower solids fraction having a higher concentration of solids, and having at least one compartment, said floc tank comprising:
(a) at least one jet manifold member mounted inside the periphery of at least one compartment;
(b) a plurality of jet nozzles mount on, and in communication with, the at least one jet manifold member;
(c) a fluid supply manifold in communication with the at least one jet manifold member; and
(d) a source of fluid for said fluid supply manifold.

In another aspect the invention provides a floc tank, for separate drilling fluid into an upper fluid fraction having a reduced concentration of solids and a lower solids fraction having a higher concentration of solids, and having at least one compartment, said floc tank comprising:
(a) at least one jet manifold member mounted underneath the bottom wall of the at least one compartment;
(b) a plurality of jet nozzles mounted from, and in communication with, the at least one jet manifold member, said nozzles sealably projecting into the bottom of said at least one compartment;
(c) a fluid supply manifold in communication with the at least one jet manifold member; and
(d) a source of fluid for said fluid supply manifold.

In yet another aspect the invention provides a floc tank, for separate drilling fluid into an upper fluid fraction having a reduced concentration of solids and a lower solids fraction having a higher concentration of solids, and having at least one compartment, said at least one compartment being generally cylindrical in shape.

Additional aspects, including method aspects, are also provided.

### BRIEF DESCRIPTION OF THE DRAWINGS

FIG. 1 is a top view of one embodiment of the present invention;

FIGS. 2-5 are side and end views of the embodiment of FIG. 1;

FIG. 6 is a side view of a second embodiment of the present invention;

FIG. 7 is a side view of a third embodiment of the present invention;

FIG. 8 is a side view of a fourth embodiment of the present invention; and

FIGS. 9-12 are various views of a fifth embodiment of the present invention.

### DETAILED DESCRIPTION OF THE PREFERRED EMBODIMENTS

Reference is to be had to the Figures in which identical reference numbers identify similar components. The drawing figures are not necessarily to scale and certain features of the invention are shown in somewhat schematic form in the interest of clarity and conciseness

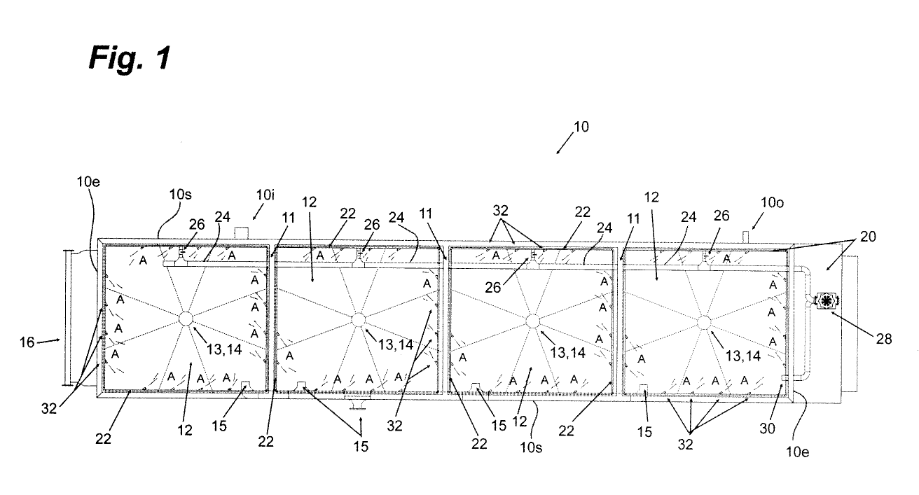

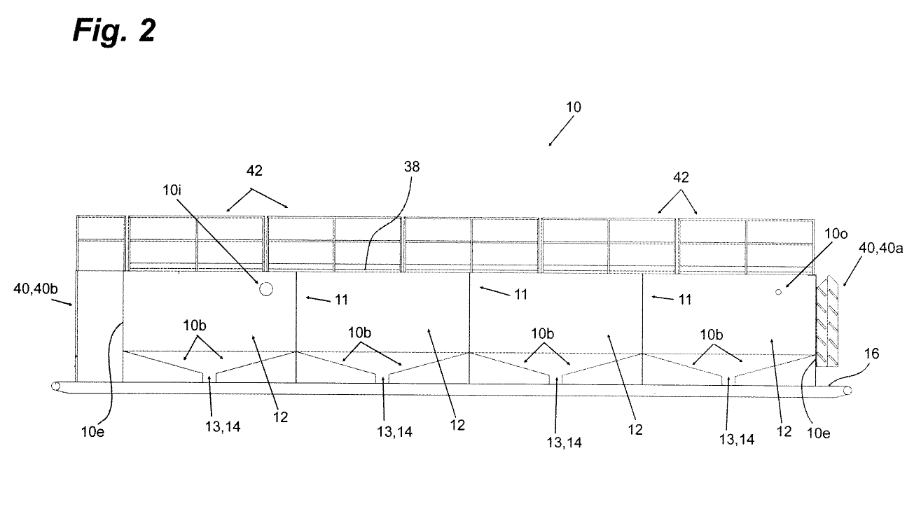

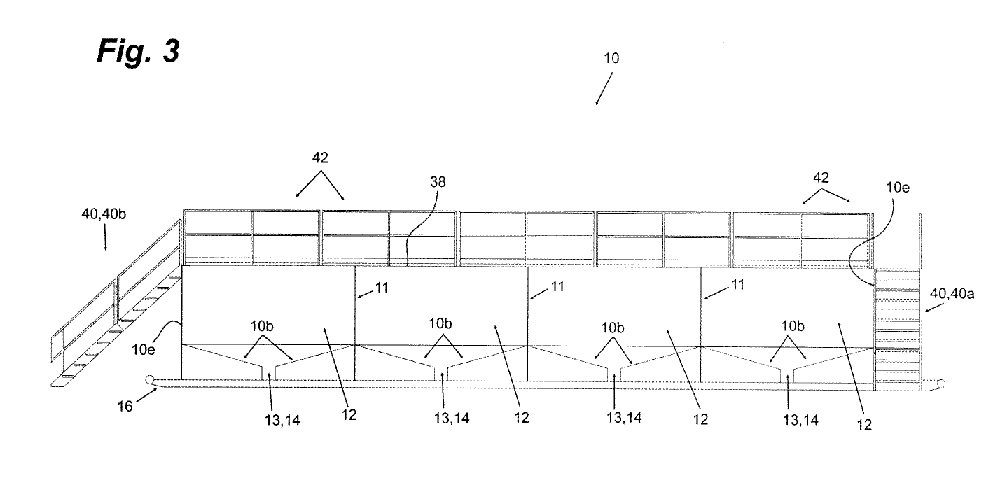

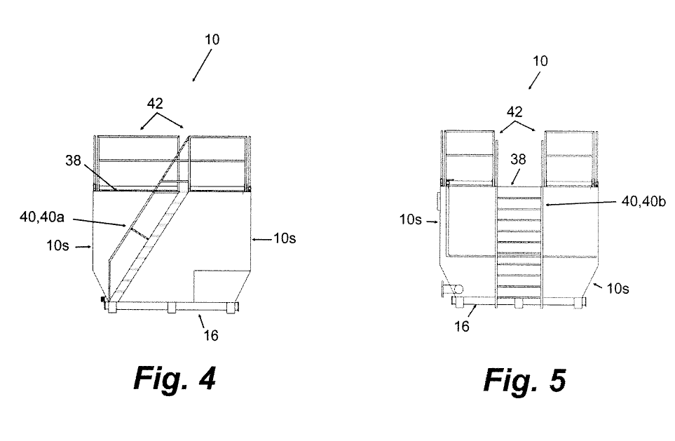

Referring to FIGS. 1-5 one embodiment of the floc tank 10 of the present invention is show. The floc tank 10 comprises a bottom wall or portion 10b, side walls 10s, end walls 10e, one or more interior baffles, weirs or over-flow walls 11 that extend transversely between the tank's side walls 10s separating the floc tank's volume into a plurality of chambers or compartments 12, an inlet 10i to receive drilling fluid, mud and/or shale slurry from a mud tank (not show), shale shaker (also not shown) or other source, and an outlet 10o to allow fluid having been treated by the floccing operations to be directed back to the drilling rig (not shown).

As drilling fluid flows from the inlet 10i into the first compartment 12 and on over the weirs 11 into the remaining compartments 12, the floc tank 10 acts to separate the drilling fluid into an upper fluid fraction having a reduced concentration of solids and a lower solids fraction having a higher concentration of solids. This is in accordance with the prior art method of floccing operations wherein the weirs or baffles 11 serve to slow the flow of drilling fluid through the compartments 12 of the tank 10 to allow solids in the drilling fluid time to settle due to gravity and concentrate towards the bottom of each compartment 12. Therefore the drilling fluid at the top of each compartment 12 tends to have a lower solids concentration, and it is this fluid that overflows to the next compartment 12 with the result that the drilling fluid has less solids as it travels to downstream chambers.

Preferably the floc tank 10 comprises a plurality of sumps or collection areas 13 and a plurality of drain openings 14, with one of each such sump 13 and drain opening 14 located in approximately the center of each compartment 12 on or near the bottom portion 10b. Sump 13 provides a convenient location in which the lower solids fraction of the drilling fluid tends to concentrate.

More preferably the drain openings 14 are valved and connect to a main drain manifold or conduit 15. Preferably these valves are gate valves. Even more preferably the bottom portion 10b in each compartment 12 is angled inwardly, concave or funnel-shaped to direct settling solids to sump 13 and to facilitate draining of the compartment 12. Yet even more preferably, the drains 14, and the main drain conduit 15 if present, are adapted to easily connect to a vacuum line from a vacuum truck. Yet even more preferably, the floc tank 10 is mounted on a skid 16 for ease of transportation.

In accordance with the present invention, an improved solids removal system is provided and generally designated by the numeral 20 in the figures. The solids removal system 20 for the floc tank 10 is characterized by a plurality of fluid jet manifold members or conduits 22 which are mounted around the inside periphery of each of the tank's compartments 12.

In this embodiment the peripheral manifold members 22 are each arranged in a helical or spiral pattern around or adjacent the inside periphery of each of their relevant compartment 12, terminating in a dead or closed end. In alternate embodiments (not shown), the manifold members 22 are arranged in a single plane around or adjacent a compartment's inside periphery near either: (a) the top of the floc tank's sidewalls 10s, (b) the bottom of the floc tank's sidewalls 10s or (c) the middle of the floc tank's side walls 10s. In yet an alternate embodiment (not show), the manifold members 22 are arranged in multiple planes around or adjacent a compartment's inside periphery, at various levels along the sidewall 10s and baffle wall 11, each planar peripheral arrangement connected to adjacent planar arrangements via a section of manifold 22 with the last, or downstream, planar arrangement terminating in either a dead end or being a planar loop.

The peripheral manifolds 22 are connected to a fluid supply manifold or conduit 24. Preferably, peripheral manifolds control valve 26 are provided between the fluid supply conduit 24 and each of the peripheral jet manifolds 22 in their respective compartment 12, so that each compartment 12 can be cleaned out separately, or all compartments together, as may be desired.

The fluid supply conduit 24 is connected to a source of fluid, preferably by way of a pump 28. Preferably, and so as to minimize the amount of additional water that may be required to clean out the floc tank 10, the pump 28 is connected to draw fluid or fluid from the floc tank's interior volume via a pump inlet 30. More preferably, the pump 28 is a centrifugal pump so that it will not be damaged by any solids that might still be present in the source of fluid. Even more preferably, the pump inlet 30 is at a level on the sidewall 10s above the general mud and slurry settlement level in the compartment 12 that houses the outlet 10o and which would have drilling fluid with the lowest solid content. An inlet located in the compartment that is furthest downstream from the tank's inlet 10i, and positioned about a foot above the bottom portion 10b, will usually be sufficiently high so as be above the slurry and shale settlement level. In another embodiment (not shown) the source of fluid is atmospheric air and the pump is a high capacity air pump.

Each of the compartment's peripheral manifolds 22 are provided with a plurality of spaced apart jet nozzles 32. Preferably, the directional pattern and spacing of the nozzles 32 and is such that the fluid exiting from each of the nozzles 32 of each manifold 22 impart a substantial vortical or helical flow pattern to any drilling fluid in the manifold's respective compartment 12. In this embodiment, the directional pattern and spacing of the nozzles 32 provides for a generally counter-clockwise vortical flow pattern around the centrally located drain opening 14, when viewed from above, and is indicated by the short directional lines A (see FIG. 1). Preferably, the nozzles 32 are adjustably mounted on the peripheral manifold 22 to facilitate optimal adjustment and directional positioning.

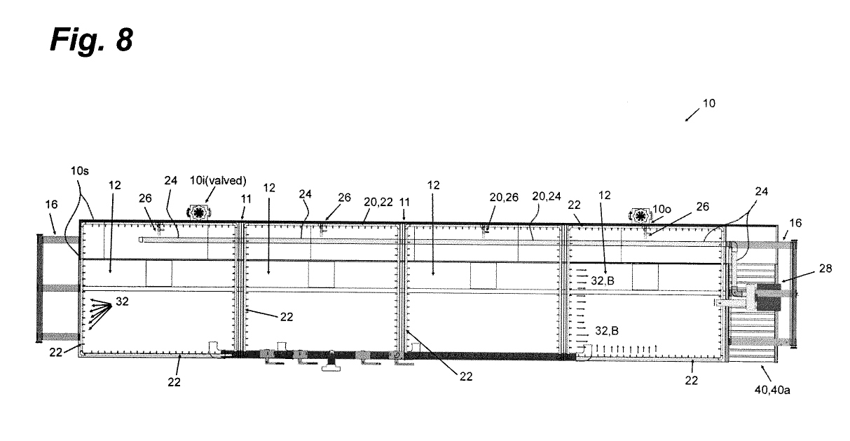

It will be appreciated that other directional patterns and spacings of the nozzles 32 will also work, such as a generally clockwise vortical flow pattern around a centrally located drain opening or a generally linear direction from each nozzle towards a centrally located drain so as to create a very turbulent mixing of the fluid in the compartment 12 (see FIG. 8).

Operation:

In a preferred embodiment, a method of operating the solids removal system 20 comprises the steps of:
pumping drilling fluid or mud taken from within the tank's volume through one or more of the peripheral manifolds 22 and out through the plurality of nozzles 32 of said manifolds 22 in the desired compartments 12;
agitating any settled mud, solids or core material on a compartment's bottom portion 10b and re-suspend the same in the drilling fluid or mud;
once all the settled mud, solids or core material from the relevant compartments 12 has been re-suspend, draining the volume of drilling fluid from said relevant compartments 12, along with the re-suspended settled mud, solids or core material, through the relevant drains 14.

In an alternate embodiment (not shown), the floc tank 10 has no drains 14 nor a main drain conduit 15, but is otherwise the same as the embodiment of FIGS. 1-5. In this embodiment a preferred method of operating the solids removal system 20 comprises the steps of:
pumping drilling fluid or mud taken from within the tank's volume through one or more of the peripheral manifolds 22 and out through the plurality of nozzles 32 of said manifolds 22 in the desired compartments 12;
agitating any settled mud, solids or core material on a compartment's bottom portion 10b and re-suspend the same in the drilling fluid or mud;
once all the settled mud, solids or core material from the relevant compartments 12 has been re-suspend, using a vacuum line to vacuum out the relevant compartments' volume of fluid and re-suspended mud, solids or core material into a vacuum truck.

Covered Top:

Preferably the top opening of the floc tank 10 is covered so as to prevent entry into the tank's compartments 12 by workers. In this embodiment the tank 10 is covered by a 1″×3″ grated roof 38 to permit sampling of the fluid in the tank's various compartments 12. In an alternate embodiment (not shown) the tank 10 is covered by a solid roof having sampling ports at desired locations above each of the compartments. Preferably, two sets of stairs 40 and a cat walk 42 are provided to facilitate movement over top of the floc tank 10. More preferably the stairs 40 fold for ease of transportation of the floc tank 10.

Height of Tank:

Even more preferably, the height of the sidewalls 10s is so that the top of the floc tank and its roof will be level with that of the height of a standard oilfield mud tank, so that an operator or worker moving from the top of a mud tank (usually placed adjacent a floc tank) to another location on the drilling site by walking over top of the floc tank's roof will not have to step up or down, but rather the roof and cat walk pathway is level with that of the top of a mud tank.

### Additional Embodiments

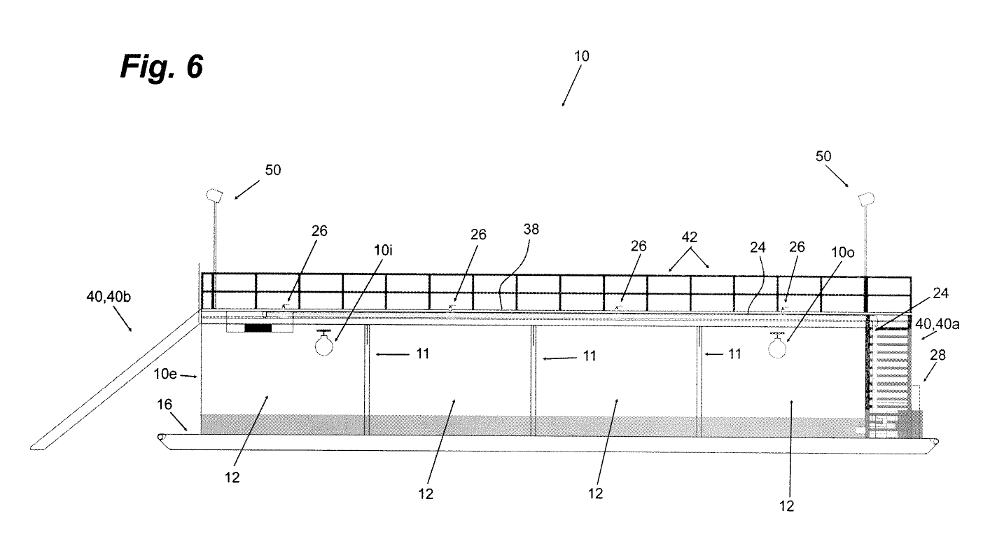

Referring now to FIG. 6, a second embodiment of the floc tank 10 is shown. This embodiment is like that of FIGS. 1-5, except that the set of stairs 40, 40a at one end is permanently fixed in place (i.e. non-folding) and the pump 28 is advantageously placed underneath said stairs 40a. Preferably, the cat walk 42 of this embodiment further comprises on or more lights 50 mounted on stands to illuminate the top of the floc tank 10.

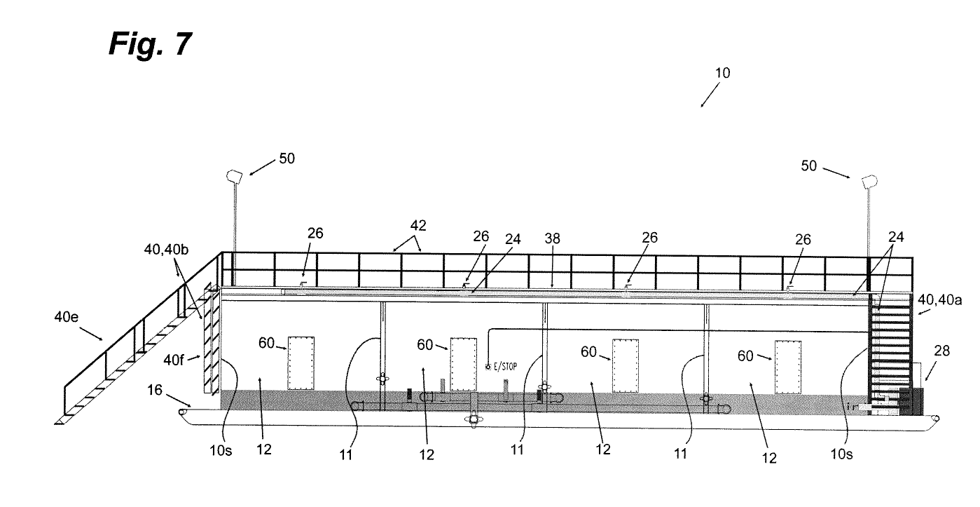

Referring now to FIG. 7, a third embodiment of the floc tank 10 is shown. This embodiment is like that of FIG. 6, except that the set of stairs 40, 40b at one end is illustrated both in the folded (40f) and extended (40e) positions and the floc tank 10 further comprises maintenance doors 60 bolted to the floc tank's sidewalls 10s so as to sealably cover maintenance entrances (not shown) and facilitate entry into the tank 10 for maintenance purposes when the tank is not in use.

Referring now to FIG. 8, a fourth embodiment of the floc tank 10 is shown. This embodiment is like that of FIGS. 1-5, except that the nozzles 32 are mounted on the peripheral manifold 22 in a generally linear direction so as to direct fluid flow from each nozzle at the periphery towards a centrally located drain, said fluid flow generally indicated by short directional lines B.

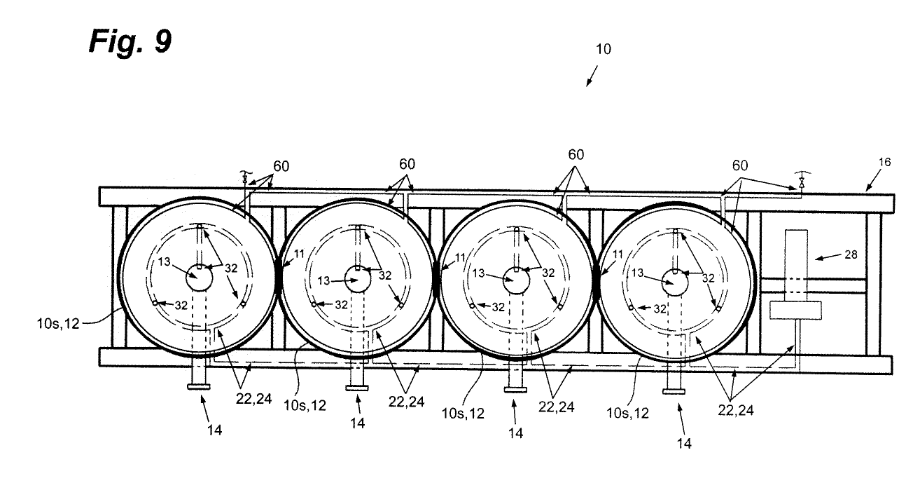

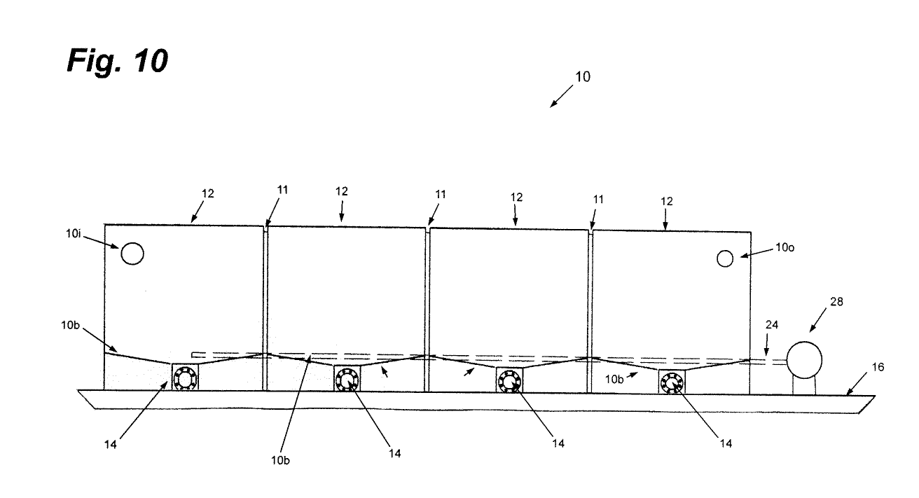

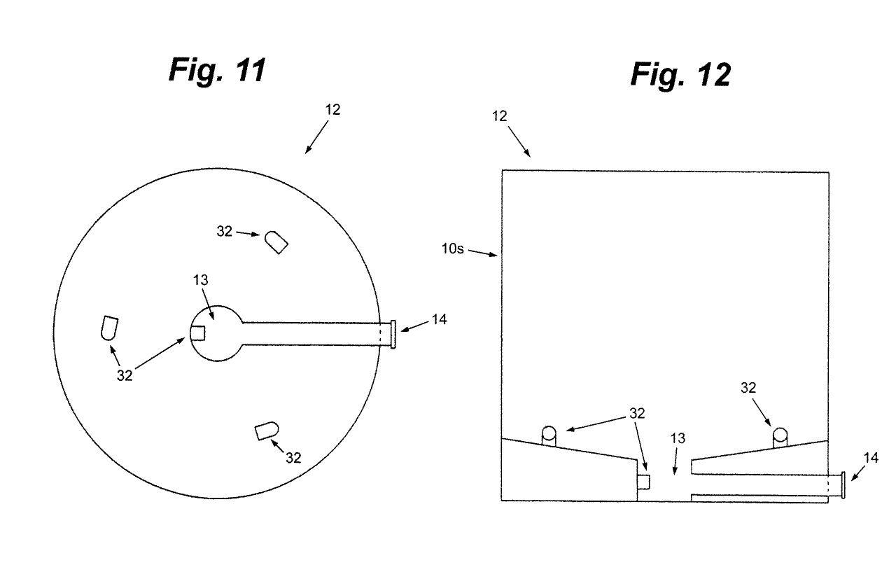

Referring now to FIGS. 9-12, a fifth embodiment of the floc tank 10 is shown. This embodiment is like that of FIGS. 1-5 with the following notable exceptions.

First, the shape of each of the compartments is novel in that the compartments are generally cylindrical in shape (not the traditional cube shape). Short sections of adjacent cylindrical walls are modified into weirs or baffle walls 11 to facilitate flow of drilling fluid from one cylindrical compartment 12 to the next in the traditional floc tank manner. The inventor has observed that this cylindrical shape provides a significant increase in overall settling and flocculation of the drilling fluid, with the drilling fluid separating very quickly into the upper fluid fraction having a reduced concentration of solids and the lower solids fraction having a higher concentration of solids. The inventor has also observed that this general cylindrical shape of the compartments 12 reduce the amount of flocculating agent or chemical required.

Second, in this embodiment the jet nozzles 32 are positioned on bottom wall 10b around the sump 13 rather than on the side walls 10s and/or baffle walls 11. Further, in this embodiment the manifolds 22 are located below the bottom wall 10b with only the jet nozzles 32 projecting (sealably) through the bottom wall 10b. Advantageously, by positioning the manifold outside of the compartment 12, it will not disturb or interrupt any of the circular or vortical flow of fluid that the fluid which exits the jet nozzles 32 imparts to the drilling fluid in the compartment 12.

More advantageously, by positing the jet nozzles on the bottom wall 10b an operator can selectively re-suspend only the lower solids fraction by using short and brief bursts of fluid through the nozzles 32. Even more advantageously, by only re-suspending or agitating the lower solids fraction, an operator can then easily drain down said re-suspended lower solids fraction through the drains 14 while not disturbing, and not re-suspending, the upper fluid fraction; thereby allowing an operator to remove the lower solids fraction only while not requiring a complete shut down of the drilling and/or floccing operations as is the case when cleaning out the traditional floc tanks.

Preferably, this embodiment of the tank 10 further comprises a jet nozzle 32 positioned in the sump 13 so as to direct the fluid exiting therefrom into the drain 14.

Third, this embodiment further comprises a heat tracing system 60 inside each of the compartments 12. Preferably the heat tracing system 60 comprises a section of ½ inch diameter re-circulating reinforced steam line, looped around the inside circumference of each compartment's bottom wall 10b and capable of being hooked up to a source of rig steam usually provided at well site drilling operations. Alternatively, the heat tracing system 60 is a continuous glycol re-circulating system. Advantageously, the heat tracing system 60 ensures that the floc tank 10 is free from ice build up during winter operations, thereby eliminating costly downtime as a result of freeze-ups and the need to manually insert or immerse a steam line or steam wand into one or more of the floc tank's compartments 12.

The embodiments of the invention in which an exclusive property or privilege is being claimed are defined as follows:

1. A floc tank, for separate drilling fluid into an upper fluid fraction having a reduced concentration of solids and a lower solids fraction having a higher concentration of solids, and having at least one compartment, said floc tank comprising:
at least one jet manifold member mounted inside the periphery of at least one compartment;
a plurality of jet nozzles mount on, and in communication with, the at least one jet manifold member;
a fluid supply manifold in communication with the at least one jet manifold member; and
a source of fluid for said fluid supply manifold.

2. The floc tank of claim 1 wherein the directional pattern of the jet nozzles inside the at least one compartment is such that any fluid exiting from the nozzles of each manifold member imparts a helical flow pattern to any drilling fluid that may be present in the respective compartment.

3. The floc tank of claim 1 wherein the source of fluid is from the upper fluid fraction.

4. The floc tank of claim 1 wherein the source of fluid is atmospheric air.

5. The floc tank of claim 1 further comprising a sloped bottom wall.

6. The floc tank of claim 1 further comprising a drain.

7. The floc tank of claim 1 further comprising a heat tracing system.

8. A floc tank, for separate drilling fluid into an upper fluid fraction having a reduced concentration of solids and a lower solids fraction having a higher concentration of solids, and having at least one compartment, said floc tank comprising:
at least one jet manifold member mounted underneath the bottom wall of the at least one compartment;
a plurality of jet nozzles mounted from, and in communication with, the at least one jet manifold member, said nozzles sealably projecting into the bottom of said at least one compartment;
a fluid supply manifold in communication with the at least one jet manifold member; and
a source of fluid for said fluid supply manifold.

9. The floc tank of claim 8 wherein the directional pattern of the jet nozzles inside the at least one compartment is such that any fluid exiting from the nozzles of each manifold member imparts a helical flow pattern to the lower solids fraction of any drilling fluid that may be present in the respective compartment.

10. The floc tank of claim 8 wherein the source of fluid is from the upper fluid fraction.

11. The floc tank of claim 8 wherein the source of fluid is atmospheric air.

12. The floc tank of claim 8 further comprising a sloped bottom wall.

13. The floc tank of claim 8 further comprising a drain.

14. The floc tank of claim 8 further comprising a heat tracing system.

15. A floc tank, for separate drilling fluid into an upper fluid fraction having a reduced concentration of solids and a lower solids fraction having a higher concentration of solids, and having at least one compartment, said at least one compartment being generally cylindrical in shape.

16. A floc tank, for separate drilling fluid into an upper fluid fraction having a reduced concentration of solids and a lower solids fraction having a higher concentration of solids, and having at least one compartment, said floc tank comprising:
a roof to cover substantially all of the top of the compartments.

17. The floc tank of claim 16 wherein the roof is a grated roof.

18. The floc tank of claim 16 wherein the roof is a solid roof.

19. A method of cleaning a floc tank containing drilling fluid, said drilling fluid having an upper fluid fraction having a reduced concentration of solids and a lower solids fraction having a higher concentration of solids, and said floc tank having at least one compartment, at least one jet manifold member and a plurality of jet nozzles mounted from, and in communication with, the at least one jet manifold member and being directed into the interior of said at least one compartment, the method comprising the steps of:
pumping drilling fluid from the upper fluid fraction through the jet manifold and out through the plurality of nozzles;
agitating the solids and re-suspend the same in the drilling fluid;
removing a volume of drilling fluid from said compartment, along with the re-suspended solids.
